(19) United States
(12) Patent Application Publication
(10) Pub. No.: US 2007/0177372 A1
(43) Pub. Date: Aug. 2, 2007

(54) PHOTOCATALYTIC MATERIAL, PHOTOCATALYST, PHOTOCATALYTIC PRODUCT, LIGHTING APPARATUS, AND METHOD OF PRODUCING PHOTOCATALYTIC MATERIAL

(75) Inventors: Ryotaro Matsuda, Yokosuka-Shi (JP); Takaya Kamakura, Yokosuka-Shi (JP); Hideki Okawa, Yokohama-Shi (JP); Ariyoshi Ishizaki, Yokohama-Shi (JP)

Correspondence Address: DLA PIPER US LLP, P. O. BOX 9271, RESTON, VA, 20195, US

(73) Assignee: TOSHIBA LIGHTING & TECHNOLOGY CORPORATION, SHINAGAWA-KU (JP)

(21) Appl. No.: 11/669,236

(22) Filed: Jan. 31, 2007

(30) Foreign Application Priority Data
Feb. 1, 2006 (JP) 2006-024918
May 31, 2006 (JP) 2006-152685

(51) Int. Cl. C01G 41/02; G09F 13/04

(52) U.S. Cl. 362/97

(57) ABSTRACT

A photocatalytic material containing tungsten trioxide fine particles having an average particle diameter of 0.5 μm or smaller and a crystal structure of a monoclinic crystal system as a main component.

### CROSS-REFERENCE TO RELATED APPLICATIONS

This application is based upon and claims the benefit of priority from prior Japanese Patent Applications No. 2006-024918, filed Feb. 1, 2006; and No. 2006-152685, filed May 31, 2006, the entire contents of which are incorporated herein by reference.

### BACKGROUND OF THE INVENTION

1. Field of the Invention

The invention relates to a photocatalytic material excitable with visible light, a photocatalyst using the photocatalytic material, a photocatalytic product, a lighting apparatus and a method of producing the photocatalytic material.

2. Description of the Related Art

As is conventionally known well, since a photocatalytic material represented by titanium oxide is a material causing an effect such as stain prevention, deodorization, or the like, the photocatalytic material has been used widely for a variety of applied products. However, since the main excitation light is ultraviolet ray, there is a problem that no sufficient function can be obtained in the case of applications indoors where ultraviolet ray is slight. Conventionally, as a countermeasure to the problem, so-called visible light-responsive photocatalysts have been enthusiastically investigated and developed. Specifically, those obtained by doping titanium oxide with nitrogen and those obtained by depositing platinum on titanium oxide have been developed. However, since the range of wavelength of visible light which titanium oxide photocatalyst excites is as narrow as 410 to 410 nm, the photocatalytic function is insufficient under indoor illumination light.

Further, as photocatalysts other than the titanium oxide types, BiVO₄ and perovskite type crystalline materials have been investigated. However, they have not yet become usable in terms of the properties and cost. Further, as other visible light-responsive photocatalysts, tungsten oxide and iron oxide have been investigated. Tungsten oxide has a band gap energy of 2.5 eV and is colored with yellow, and therefore is advantageous in the case of using it as a construction material. Tungsten oxide is a scarcely toxic and relatively economic material.

Further, tungsten oxide is relatively easily made available as an industrial material. However, tungsten oxide is commercialized in the form of secondarily sintered large particles (1 to 100 μm). Therefore, the specific surface area is narrow and in the case of using tungsten oxide for a photocatalyst, the activity is low. Additionally, tungsten oxide has two crystal systems; a monoclinic system and a triclinic system, at a normal temperature. Accordingly, the photocatalytic activity becomes unstable due to change of the crystal by a physical impact and it is difficult to produce a coating material using tungsten oxide. The photocatalytic effect of tungsten oxide by visible light is confirmed by forming a film by reactive sputtering method (refer to Jpn. Pat. Appln. KOKAI Publication No. 2001-152130, or “Photocatalysts”, p 676, issued on May 27, 2005, NTS Co.).

On the other hand, visible light-responsive photocatalysts using tungsten powders have been investigated, but presently no sufficient effect has been caused yet.

Tungsten oxide is stable in the form of tungsten trioxide (WO₃) in normal temperature atmosphere. However, tungsten trioxide has a characteristic that the crystal structure is complicated and easily changeable. In general, tungsten trioxide produced from ammonium para-tungstate and tungstic acid has a monoclinic crystal system. However, due to the stress at the time of treating a powder (for example, crushing it in a mortar), the crystal structure is easily changed to a triclinic crystal system (J. Solid State Chemistry 143, 24 32(1999)). To improve the catalytic effect of the photocatalyst, it is needed to prevent electrons excited by light and holes from recombination until they reach the surface. Accordingly, it is required to lessen defects to be the recombination centers as much as possible in the crystal of the photocatalyst and to make the particle diameter as small as possible.

So far, the tungsten oxide powder has not given a sufficient photocatalytic effect. It is supposed that the reason for this is because crystal change partially occurs at the time of processing the powder in pretreatment process and different crystals are intermixed, and the boundaries of the crystals become defects to cause recombination of electrons and holes. In the case of the film formed by a conventionally known sputtering method, it is said that sufficient catalytic effect can be obtained by using tungsten oxide of the triclinic crystal system. However, no sufficient catalytic effect is obtained with tungsten oxide powder of the triclinic crystal system.

### BRIEF SUMMARY OF THE INVENTION

An aim of the invention is to provide a photocatalytic material having a high catalytic effect and responsive to visible light by keeping a prescribed crystal structure, and a photocatalyst body and a photocatalytic product using this material.

Another aim of the invention is to provide a lighting apparatus comprising a visible light-responsive photocatalyst film which is excellent in the photocatalytic effect, is scarcely colored with tungsten trioxide fine particles, and scarcely affects the lighting function.

Further, another aim of the invention is to provide a method of producing a tungsten trioxide photocatalytic material having stable crystal structure and a high photocatalyst effect.

(1) A photocatalytic material of the present invention contains tungsten trioxide fine particles having an average particle diameter of 0.5 μm or smaller and a crystal structure of a monoclinic crystal system as a main component.

Herein, the average particle diameter of tungsten trioxide is preferably in a range of 0.01 to 0.1 μm and most preferably in a range of 0.02 to 0.05 μm. The inventors of the invention have made various investigations on the photocatalytic activity of tungsten trioxide. As a result, they have found that tungsten trioxide having the crystal structure of monoclinic crystal system and specified particle diameter is more excellent in the visible light response and photocatalytic activity than that having the crystal structure of triclinic crystal system, which had been considered highly effective.

As the average particle diameter of the fine particles is smaller, the specific surface area is larger and the ratio of electron-hole recombination tends to be decreased more. Therefore, it is convenient for improving the photocatalytic activity. The lower limit of the average particle diameter possible to be formed stably is 0.01 μm. That “the tungsten trioxide fine particles with the monoclinic crystal system are used as a main component” means that the triclinic crystal system may be mixed with the monoclinic crystal system. Particularly, if 50% by mass, preferably 70% by mass, of tungsten trioxide has the crystal structure of monoclinic crystal system, an efficient photocatalytic effect can be obtained. Further, the chemical formula of tungsten trioxide is WO₃. However, according to the analysis of the crystal structure of the fine particles, even tungsten oxide having 2.8 or 2.9 as an atomic ratio x of oxygen in WOₓ may be defined as the tungsten trioxide of the invention as long as it has the crystal structure of monoclinic crystal system.

According to the above-mentioned photocatalytic material, it is made possible to obtain a visible light-responsive photocatalytic material excellent in the photocatalytic effect by causing the photocatalytic activity while keeping the crystal structure of the tungsten trioxide fine particles in the state of monoclinic crystal system.

(2) A photocatalyst body of the present invention comprises a layer of the photocatalytic material according to (1) formed on a substrate surface and a photocatalyst film containing tungsten trioxide fine particles maintaining a crystal structure of a monoclinic crystal system and formed on the layer of the photocatalytic material. According to the above-mentioned photocatalyst body, it is made possible to obtain a photocatalyst body having a photocatalyst film formed of the photocatalytic material excellent in the photocatalytic effect.

(3) A photocatalytic product of the present invention comprises a photocatalyst filter and a light emitting diode which radiates light including at least blue color light to the photocatalyst filter, wherein the photocatalytic material according to (1) is deposited on the photocatalyst filter and tungsten trioxide fine particles maintain a crystal structure of a monoclinic crystal system after deposition. According to the photocatalytic product of the invention, it is made possible to obtain a photocatalytic product comprising the photocatalytic material excellent in the photocatalytic effect.

(4) A lighting apparatus of the present invention comprises a light source, a light transmissive cover substrate enveloping the light source, and a photocatalyst layer formed on an outer face or an inner face of the cover substrate and containing tungsten trioxide fine particles having an average particle diameter of 0.1 μm or smaller and a crystal structure of a monoclinic crystal system.

In the lighting apparatus, it is made possible to obtain a photocatalyst by using the photocatalyst layer containing tungsten trioxide fine particles as a main component and adding 5 to 50% by weight, preferably 10 to 20% by weight, of a binder component such as acryl-modified silicon, silicone type resin, SiO₂, ZrO₂, and Al₂O₃ with high visible light and ultraviolet transmittance to the tungsten trioxide fine particles. Use of the photocatalytic material mixed with such a binder component makes it possible to form a photocatalyst layer at a room temperature by coating. Accordingly, there is no need to install special facilities such as a high temperature heating apparatus. On the other hand, if the average particle diameter of the tungsten trioxide fine particles exceeds 0.1 μm, the fine particles are seen to be colored with yellow, and therefore, the photocatalyst layer formed in the lighting apparatus or the radiation light is seen to be discolored. Accordingly, it is preferable to adjust the average particle diameter of the tungsten trioxide fine particles to be 0.1 μm or smaller. In addition, with respect to the lighting apparatus, the photocatalyst layer may be formed using the tungsten trioxide fine particles alone.

According to the lighting apparatus of the invention, the photocatalyst layer containing tungsten trioxide fine particles with an average particle diameter of 0.1 μm or smaller and having the monoclinic crystal system is formed on a substrate surface of a light transmissive cover or a reflection plate of the lighting apparatus. Therefore, it is made possible to obtain the lighting apparatus provided with a visible light-responsive photocatalyst film excellent in the photocatalytic effect, scarcely affecting the lighting effect and having hardly noticeable coloration of the tungsten trioxide fine particles.

(5) A lighting apparatus of the present invention comprises a light source, a reflection plate substrate set optically on the opposite to the light source, and a photocatalyst layer formed on the reflection plate substrate and containing tungsten trioxide fine particles having an average particle diameter of 0.1 μm or smaller and a crystal structure of a monoclinic crystal system.

In the lighting apparatus, the photocatalyst layer contains the tungsten trioxide fine particles as a main component and may additionally contain a prescribed amount of fine particles of titanium oxide, nitrogen-substituted titanium oxide or platinum-deposited titanium oxide. The photocatalyst layer may be formed by adding 5 to 50% by weight, preferably 10 to 20% by weight, of a binder component such as acryl-modified silicon, silicone type resin, SiO₂, ZrO₂, and Al₂O₃ with high visible light and ultraviolet transmittance to the tungsten trioxide fine particles. The photocatalyst layer can be formed by heating the applied photocatalytic material at a temperature in a range from a room temperature to 120° C.

(6) A method of producing a photocatalytic material of the present invention comprises the steps of producing a granular raw material by spraying an aqueous solution containing 1 to 20% by weight of ammonium para-tungstate in high temperature atmosphere, and forming tungsten trioxide fine particles having a crystal structure of a monoclinic crystal system by heating the granular raw material at 700 to 800° C. for 1 to 10 minutes. According to the method of producing the photocatalytic material of the invention, since the granular raw material is produced from fine liquid-phase colloid generated by spraying an aqueous solution, it is made possible to obtain crystalline photocatalyst fine particles of tungsten trioxide with scarce crystal growth and few oxygen defects.

(7) A method of producing a photocatalytic material of the present invention comprises the steps of dissolving ammonium para-tungstate in a water-based solvent and successively carrying out recrystallization, and forming a tungsten trioxide photocatalytic material by firing the obtained crystal in conditions of 600° C. or higher for 15 seconds or longer. Herein, as the ammonium para-tungstate, crystal obtained by previous recrystallization of commercialized ammonium para-tungstate in water may be used. Firing may be carried out in atmospheric air. The firing temperature and the firing time are determined based on the fact that the optimum conditions are 800° C. and 1 minute. However, an upper limit of the firing temperature is 1000° C., and an upper limit of the firing time is 15 minutes. The firing temperature exceeds 1000° C., a primary grain size of WO₃ becomes large, activity is lessened. And, it is unfavorable that if the firing time exceeds 15 minutes, crystallization grows and its grains size increases.

According to the method of producing the photocatalytic material of the invention, the visible light-responsive tungsten trioxide material excellent in photocatalytic activity can be obtained by firing the recrystallized ammonium para-tungstate at a prescribed temperature for a prescribed time.

### BRIEF DESCRIPTION OF THE SEVERAL VIEWS OF THE DRAWING

FIGS. 1A and 1B show schematic explanatory drawings of a fluorescent lamp according to the invention;

FIGS. 2A and 2B show conceptual explanatory drawings of a deodorization unit according to the invention;

FIG. 3 shows X-ray diffraction data of monoclinic crystal system WO₃ which is a main component of the photocatalyst powder of the invention;

FIG. 4 shows X-ray diffraction patterns of triclinic crystal system and monoclinic crystal system of tungsten trioxide (WO₃);

FIG. 5 shows a characteristic drawing showing the comparison of acetaldehyde decomposition effects in the case where the crystal structures of tungsten trioxide differ;

FIG. 6 shows a conceptual drawing of a measurement apparatus employed for obtaining the characteristic drawing of FIG. 5;

FIG. 7 shows a conceptual drawing of a production apparatus for producing the photocatalytic material of the invention;

FIG. 8 shows a graph of particle size distribution (the relation among frequency, the particle diameter and the integrated penetration) after dispersion;

FIG. 9 shows a graph of particle size distribution (the relation among frequency, the particle diameter and the integrated penetration) of the WO₃-dispersed coating material;

FIG. 10 shows a microscopic photograph of ammonium meta-tungstate as a granular raw material obtained in a third embodiment;

FIG. 11 shows a microscopic photograph of monoclinic crystal system type WO₃ crystal photocatalyst fine particles obtained by rapid and short time heating of the granular raw material obtained in the third embodiment at 800° C. for 1 to 10 minutes;

FIG. 12 shows a characteristic drawing showing the acetaldehyde decomposition capability of the respective tungsten trioxide photocatalyst fine particles obtained by firing at a temperature of 600° C., 700° C., 800° C., and 900° C. in a fourth embodiment;

FIG. 13 shows a characteristic drawing showing the acetaldehyde decomposition capability of the respective tungsten trioxide photocatalyst fine particles obtained by firing at a temperature of 600° C., 700° C., 800° C., and 900° C. in the fourth embodiment;

FIG. 14 shows a characteristic drawing showing the acetaldehyde decomposition capability in the case where the firing time is changed to be 30 seconds, 1 minute, 5 minutes, 10 minutes, and 15 minutes;

FIG. 15 shows a drawing showing the relation between the wavelength and the reflectivity in the case of using WO₃ photocatalyst of a sixth embodiment and TiO₂ photocatalyst;

FIG. 16 shows a perspective view in the disassembled state of the lighting apparatus according to the sixth embodiment;

FIG. 17 shows an enlarged cross-sectional drawing of the main part of FIG. 16; and

FIG. 18 shows the relation between the time and the acetaldehyde remaining ratio by using the lighting apparatus of a seventh embodiment in combination with a TiO₂ photocatalyst-bearing fluorescent lamp, the TiO₂ photocatalyst-bearing fluorescent lamp, and a TiO₂ photocatalyst-bearing lighting apparatus in combination with the TiO₂ photocatalyst-bearing fluorescent lamp.

### DETAILED DESCRIPTION OF THE INVENTION

Hereinafter, the invention will be described more in detail with reference to drawings.

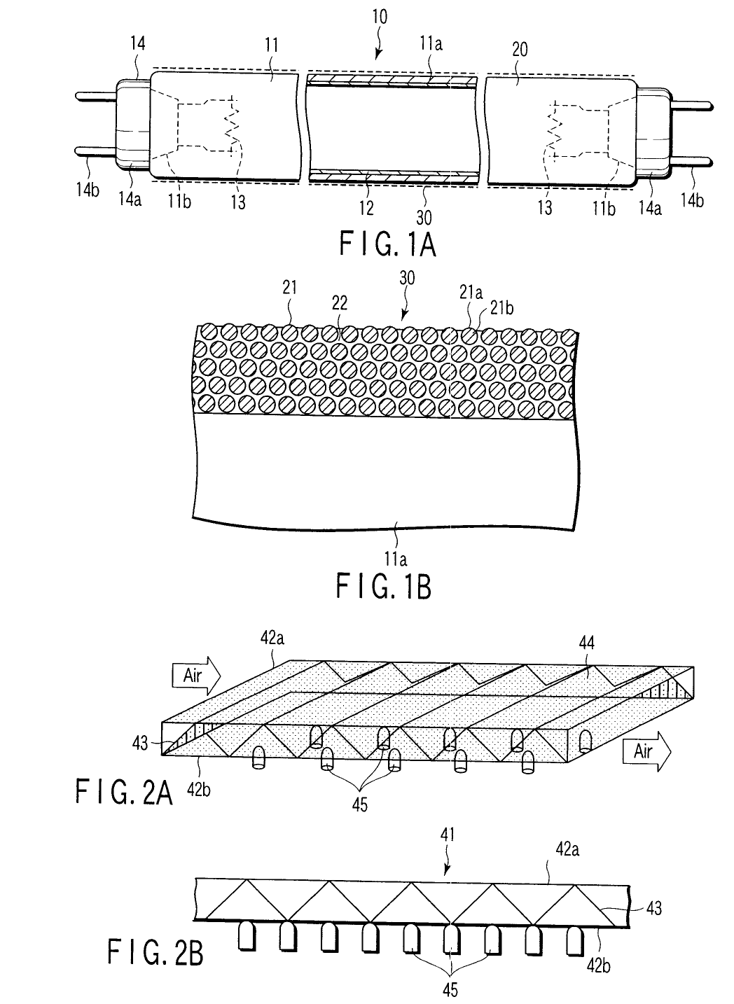

FIG. 1 is a cross-sectional view schematically showing the configuration of a fluorescent lamp according to the invention. FIG. 1A shows a cross-sectional view including the cut cross-sectional view and FIG. 1B is a schematic cross-sectional view of a photocatalyst film, which is one component of the above-mentioned fluorescent lamp.

The reference numeral 10 in the drawing shows a fluorescent lamp as a photocatalytic product and comprises a fluorescent lamp main body 20 and a photocatalyst film 30 formed on the surface of the fluorescent lamp main body 20. The fluorescent lamp main body 20 comprises a light transmissive electric discharge container 11, a phosphor layer 12, a pair of electrodes 13 and 13, an electric discharge medium, which is not illustrated, and a base 14.

The container 11 is composed of a thin and long glass bulb 11a and a pair of flare stems 11b. The glass bulb 11a is made of soda-lime glass. Each flare stem 11b is provided with a gas discharge pipe, a flare, an inner lead wire, and an outer lead wire. The gas discharge pipe is employed for discharging the gas out of the inside of the container 11 by communicating the inside and outside of the container 11 and enclosing an electric discharge medium. The gas discharge pipe is sealed after the enclosure of the electric discharge medium. The flare is attached to both ends of the glass bulb 11a to form the light transmissive electric discharge container 11. The base end of the inner lead wire is air-tightly buried in the inside of each flare stem 11b and the inner lead wire is connected with the outer lead wire. The tip end of the outer lead wire is buried in each flare stem 11b and the base end thereof is led outside of the light transmissive electric discharge container 11.

The phosphor layer 12 contains three-light emitting type phosphors and formed in the inner face of the light transmissive electric discharge container 11. The three-light emitting type phosphors are BaMgAl₁₆O₂₇:Eu for blue light emission, LaPO₄:Ce for green light emission, and Y₂O₃:Eu for red light emission. The pair of the electrodes 13 and 13 are connected between the tip end parts of the pair of the inner lead wires set on the opposite to each other at a distance in both inner ends of the light transmissive electric discharge container 11. Each electrode 13 comprises a coil filament of tungsten and an electron emitting substance attached to the coil filament.

The electric discharge medium contains mercury and argon and is enclosed in the inside of the light transmissive electric discharge container 11. A proper amount of mercury is enclosed through the gas discharge pipe. Argon is enclosed at about 300 Pa in the light transmissive electric discharge container 11. Each cap 14 comprises a cap main body 14a and a pair of base pins 14b and 14b. The cap main body 14a has a cap-like shape and attached to both end parts of the light transmissive electric discharge container 11. The pair of the cap pins 14b and 14b are supported in each cap main body 14a while being insulated from each other and respectively connected with the outer lead wire.

The photocatalyst film 30 is a film of a photocatalyst coating material containing tungsten trioxide fine particles (average particle diameter: 0.1 μm) as a main component and the film thickness thereof is about 0.5 to 3 μm. The tungsten trioxide fine particles maintain the crystal structure of the monoclinic crystal system even after completion of the coating. The photocatalyst film 30 contains photocatalyst fine particles 21 together with a binder 22 with excellent ultraviolet or visible light transmittance such as alumina fine particles, silica fine particles, or zirconia fine particles. The photocatalyst fine particles 21 are composed of tungsten trioxide fine particles 21a and calcium carbonate fine particles 21b attached to the surfaces of the tungsten trioxide fine particles 21a. The binder 22 is added in an amount of 10 to 50% by weight to the tungsten trioxide fine particles 21a. If acryl-modified silicon and silicone type resins are used for the binder 22, the photocatalyst film can be cured at 20 to 200° C. Further, the calcium carbonate fine particles 21b work as a substance for absorbing NOₓ (nitrogen oxide) and SOₓ (sulfur oxide). Accordingly, if there is no need to suppress deterioration of the tungsten trioxide fine particles 21a due to NOₓ and SOₓ, it is not essential to add the calcium carbonate fine particles 21b.

FIG. 2 is an explanatory drawing schematically showing the configuration of a deodorization unit according to the invention. FIG. 2A shows a schematic perspective view of the deodorization unit and FIG. 2B shows a schematic side face of the unit shown in FIG. 2A. FIG. 2B does not show tungsten trioxide fine particles for convenience.

The reference numeral 41 in the drawings shows a deodorization unit as a photocatalytic product. A deodorization unit 41 comprises first and second, upper and lower, flat mesh-like filters 42a and 42b and a third filter 43 having corrugated cross-sectional shape and disposed between the filters 42a and 42b. Tungsten trioxide fine particles (average particle diameter: 0.1 μm) 44 of the invention are deposited on the respective filters 42a, 42b, and 43. A plurality of GaN blue-emitting diodes 45 are installed under the second filter 42b. In this case, in place of the diodes 45, white-emitting diodes using phosphors excited by blue light may be installed. In the deodorization unit with such a configuration, when air passes, for example, from the left side to the right side through the third filter 43 between the first and the second filters 42a and 42b, the air is deodorized by being in contact with the tungsten trioxide fine particles deposited on the respective filters 42a, 42b, and 43.

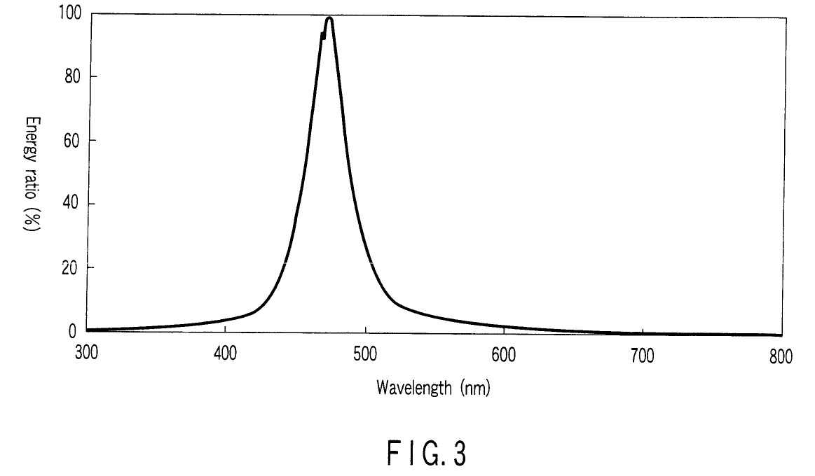

In the invention, the average particle diameter of tungsten trioxide (WO₃) fine particles is adjusted to be 0.5 μm or smaller and preferably 0.1 μm or smaller. Herein, when the average particle diameter exceeds 0.5 μm, the probability of occurrence of the reaction in the surfaces of the fine particles is decreased and no sufficient catalytic effect can be obtained. Further, the crystal structure of the tungsten trioxide is the monoclinic crystal system, and the crystal structure tends to easily change to the triclinic crystal system only by crushing tungsten trioxide in a mortar. Accordingly, it is important to keep the monoclinic crystal system. FIG. 3 shows spectroanalysis spectrum of the blue-emitting diode 45 used in the deodorization unit shown in FIG. 2. It is understood from FIG. 3 that radiation light of the blue-emitting diode 45 has a specific energy peak around 470 nm.

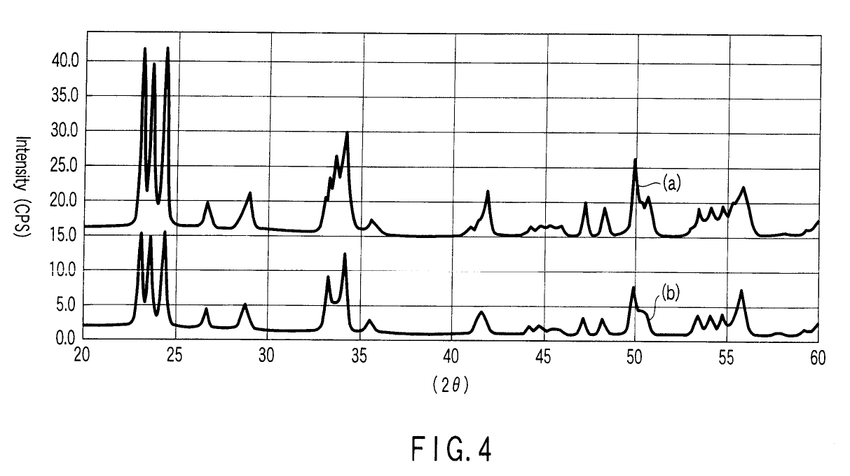

FIG. 4 shows an X-ray diffraction pattern graph of tungsten trioxide (WO₃) of the triclinic crystal system and monoclinic crystal system. The X-ray diffraction pattern measurement is carried out as follows. That is, at first, using CuKα-beam (λ=0.15418 nm) as X-ray, a sample is rotated at an angle θ with respect to the incident X-ray beam. Simultaneously, the X-ray intensity (CPS) at every diffraction angle (2θ) is measured by a goniometer which rotates the detection part comprising a proportional counter at 2θ. In FIG. 4, (a) shows the result of triclinic crystal system WO₃ and (b) shows the result of monoclinic crystal system WO₃.

As is clear from FIG. 4, in comparison of the respective diffraction patterns of triclinic crystal system and monoclinic crystal system tungsten trioxide, most parts are analogous. However, it is confirmed that the patterns considerably differ in the range of 30 to 35° of the diffraction angle 2θ. Particularly, there are a large peak unique to the monoclinic crystal system and a plurality of small peaks unique to the triclinic crystal system at an angle 2θ=34.155°. This clearly shows the difference between the two systems.

In the case of tungsten trioxide of the monoclinic crystal system, two peaks exist in the 2θ range of 30 to 35° and in the case of tungsten trioxide of the triclinic crystal system, three or more peaks are confirmed to exist in the same range. Further, ratios of the peak value appearing in the 2θ range of 30 to 35° to the peak value in the 2θ range of 30 to 35° are as follows. That is, in the case of tungsten trioxide of the triclinic crystal system, the ratio is as low as 50 to 60%. On the other hand, in the case of tungsten trioxide of the monoclinic crystal system, the ratio is in a range from 70 to 95% and the difference of the peak value is small.

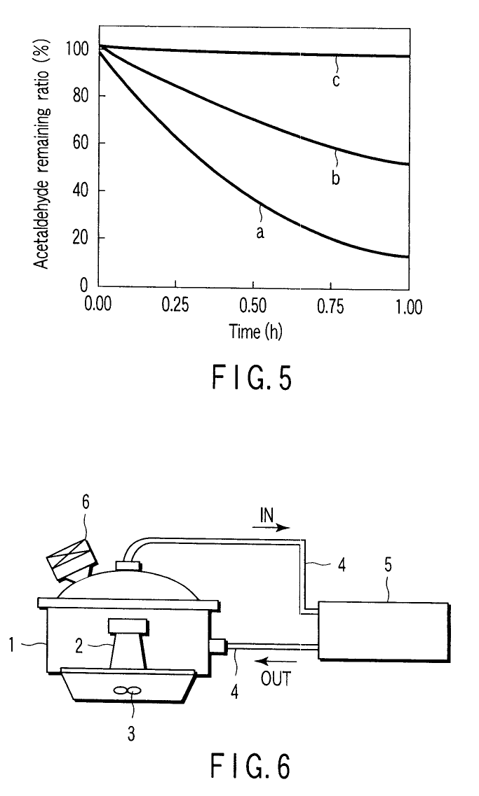

FIG. 5 shows a characteristic drawing showing the comparison of acetaldehyde decomposition effects in the case where the crystal structures of tungsten trioxide differ. In FIG. 5, the curve a shows the result using the WO₃ fine particles of the monoclinic crystal system of the invention (corresponding to (b) of the graph FIG. 4B); the curve b shows the result using WO₃ fine particles of the triclinic crystal system of Comparative Example (corresponding to (a) of the graph FIG. 4A); and the curve c shows the result in the case of using no photocatalyst and light radiation.

FIG. 6 shows a conceptual drawing of a measurement apparatus employed for obtaining the characteristic drawing of FIG. 5. The reference numeral 1 in the drawing shows a desiccator and a laboratory dish 2 containing the photocatalyst is housed in the desiccator. A fan 3 is installed under the laboratory dish 2 in the desiccator 1. A multi-gas monitor 5 is connected to an upper part and a side part of the desiccator 1 through pipes 4. Further, a blue emitting LED light source 6 for radiating light to the photocatalyst is attached slantingly to the upper part of the desiccator 1.

The design of the above-mentioned measurement apparatus is as follows.

Measurement box (desiccator) capacity: 3000 cc
Light source: blue emitting LED
Measurement device: multi-gas monitor
Introduced gas: equivalent to 10 ppm acetaldehyde

### Blue emitting LED: 0.88 mW/cm² (UV-42) and 0.001 mW/cm² (UV-35)

Powder amount of tungsten trioxide fine particles: 0.1 g

It is made clear from FIG. 5 that the gas decomposition effect is higher in the curve a than in the curve b and thus the photocatalytic effect of WO₃ of the monoclinic crystal system of the invention is more significant when visible light is radiated.

The photocatalyst coating material of the invention may include those which contain the tungsten trioxide fine particles and keep the monoclinic crystal system of the tungsten trioxide fine particles after completion of the coating. The photocatalyst coating material has a significantly excellent function including the VOC removal by the photocatalyst and suitable to be used for a deodorization filter to be used, for example, in an air purification apparatus.

The photocatalyst body of the invention may include those having a structure formed by applying the photocatalyst coating material to a substrate surface and accordingly forming a photocatalyst film. The photocatalyst body may include tubular or bulb products such as a fluorescent lamp; construction materials such as window glass, mirror, and tiles; sanitary products; filter parts of air conditioners and deodorization apparatus; and optical appliances. However, applications and categories of the photocatalyst body are not particularly limited to these exemplified spheres.

The photocatalyst product of the invention may include those comprising the above-mentioned photocatalyst coating material in combination with GaN blue-emitting diodes or incandescent light-emitting diodes using phosphors excited by blue light, and those comprising the photocatalyst filter in combination with GaN blue-emitting diodes or incandescent light-emitting diodes using phosphors excited by blue light. Herein, the photocatalytic product practically includes a fluorescent lamp, a lighting apparatus, and a deodorization unit.

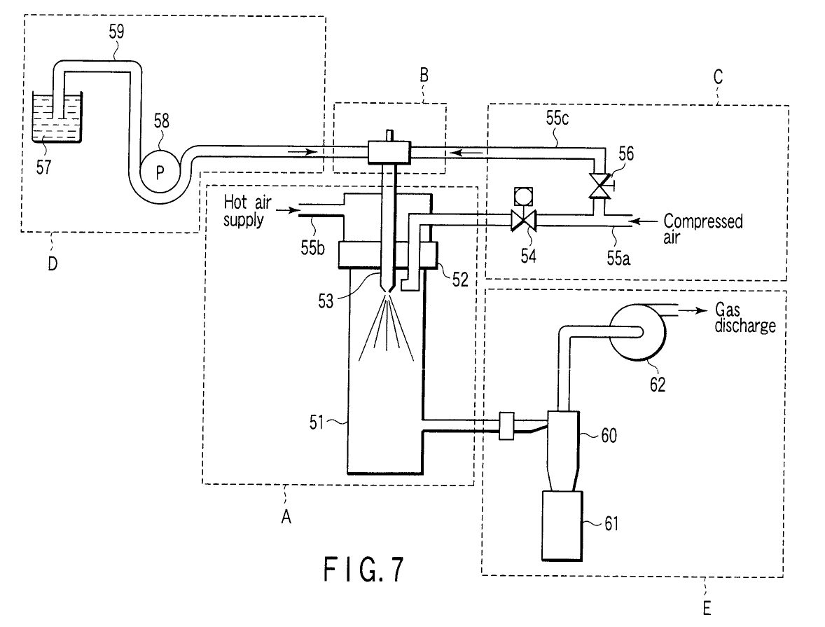

In the invention, the photocatalyst fine particles are produced by employing the production apparatus shown in FIG. 7. The production apparatus comprises a spray dryer main body A, a gas-liquid mixing part B, a compressed air introduction part C, a solution introduction part D, and a powder recovery part E. The reference numeral 51 in the drawing shows a drying chamber equipped with a distributor 52 in the upper part thereof. Herein, the distributor 52 works as an air introduction inlet for heating the drying chamber 51 to 200° C. A spraying nozzle 53 and a pipe 55a equipped with a solenoid valve 54 are installed in the drying chamber 51 while penetrating the distributor 52. The pipe 55a works as an air introduction inlet for introducing air proper for pressurizing and atomizing an aqueous solution. A pipe 55b is installed in the upper part of the drying chamber 51 to suck air through. The pipe 55b works as a hot air suction port for heating the aqueous solution and air. The pipe 55a is branched to a pipe 55c equipped with a needle valve 56.

The pipe 55c is joined to the upper part of the spraying nozzle 53. A tube 59 for supplying a sample 57 to the spraying nozzle 53 by a pump 58 is connected to the upper part of the spraying nozzle 53. The amount of the sample 57 to be supplied to the spraying nozzle 53 is made properly adjustable by the pump 58. A cyclone 60 for taking out a product sprayed in an atomized state from the spraying nozzle 53 is connected to a side part of the drying chamber 51. A product container 61 for collecting the photocatalyst fine particles and an aspirator 62 for gas discharge are respectively connected to the cyclone 60.

A temperature sensor, which is not illustrated, is installed in the inlet side and outlet side of the drying chamber 51. Owing to the temperature sensor, the temperature of air to be supplied to the drying chamber 51 and the temperature of ambient air surrounding the photocatalyst fine particles to be sent to the cyclone 60 are measured. The air to be supplied to the pipe 55c is mixed with the sample 57 supplied to the tube 59 in the upper side part of the spraying nozzle 53 and sprayed in an atomized state from a lower part of the spraying nozzle 53.

In the case of producing the photocatalyst fine particles using the production apparatus with the above-mentioned structure, the process may be carried out as follows. At first, an aqueous solution containing 1 to 20% by weight of ammonium para-tungstate (sample) is sent together with compressed air to the spraying nozzle 53. Successively, the solution is sprayed through the tip end of the spraying nozzle 53 in hot air atmosphere at 200° C. to obtain a granular raw material with a particle diameter of 1 to 10 μm. In this case, the compressed air is sent to the periphery of the tip end of the spraying nozzle 53 from the pipe 55a to supply air to the granular raw material to be sprayed by the spraying nozzle 53. Next, heating treatment is carried out at 700 to 800° C. for 1 to 10 minutes in the drying chamber 51. Consequently, it is made possible to produce photocatalyst fine particles containing tungsten trioxide fine particles as a main component and having an average particle diameter of 0.1 μm and the crystal structure of monoclinic crystal system. Successively, while the inner gas of the drying chamber 51 is evacuated by an aspirator 62, the photocatalyst fine particles in the drying chamber 51 are collected in the product container 61 by the cyclone 60.

Next, practical embodiments of the invention will be described.

### First Embodiment

A photocatalyst powder according to the first embodiment was produced as follows.

At first, ammonium para-tungstate (APT) was crushed by a bead mill or a planetary mill and classified by centrifugation. Next, the obtained fine particles were heated at 400 to 600° C. in atmospheric air to refine a photocatalyst powder of tungsten trioxide fine particles having a crystal structure of the monoclinic crystal system.

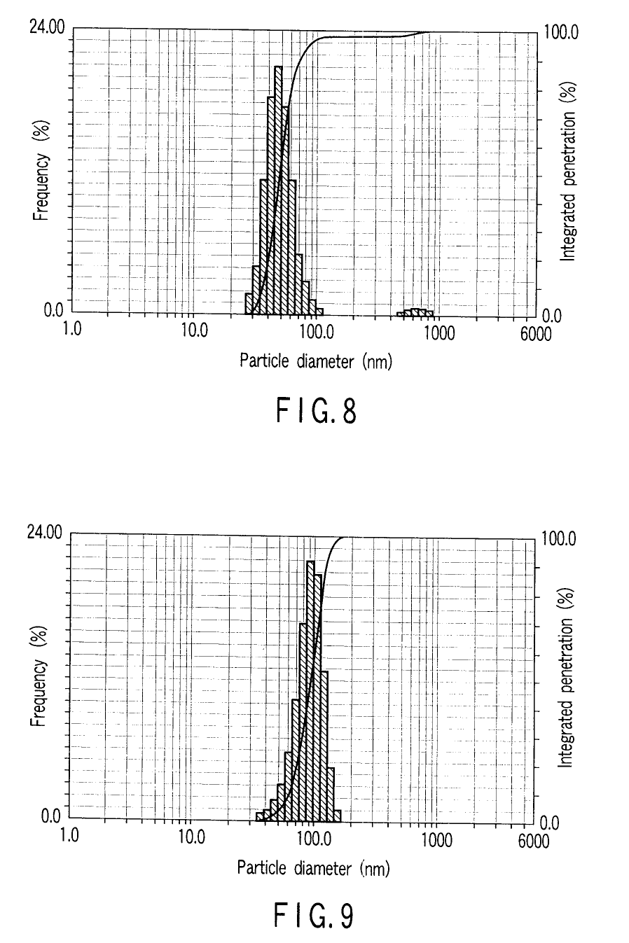

In the first embodiment, the heating treatment at about 500° C. in atmospheric air gave tungsten trioxide fine particles having an average particle diameter of about 0.1 μm and the monoclinic crystal system. The particle size distribution data in this step is as shown in FIGS. 8 and 9. Herein, FIG. 8 shows the particle size distribution (the relation among the particle diameter, the frequency and the integrated penetration) after dispersion. FIG. 9 shows the particle size distribution (the relation among the particle diameter, the frequency and the integrated penetration) of the WO₃-dispersed coating material. From FIGS. 8 and 9, it is understood that the crystal is slightly grown and the particle size becomes larger by the heating treatment.

According to the photocatalyst powder of the first embodiment, since the powder contains the tungsten trioxide fine particles with an average particle diameter of 0.1 μm as a main component and having a crystal structure of the monoclinic crystal system, the visible light-responsive photocatalyst powder with considerably improved photocatalytic function can be obtained.

### Second Embodiment

A photocatalyst coating material for indoor according to a second embodiment was produced as follows.

At first, tungsten trioxide fine particles and a trace amount of a surface treatment agent were mixed with an organic solvent (ethyl alcohol) and dispersed for several hours by a bead mill. Successively, an inorganic binder (polysiloxane) in an amount of 30% by weight to the tungsten trioxide fine particles, an organic solvent (alcohol), and pure water in an amount of several % were added and again the dispersion treatment was carried out to obtain the photocatalyst coating material. After that, calcium carbonate and magnesium hydroxide in amounts changed in a range of 0.1 to 10% by mole on the basis of the tungsten trioxide were added to the obtained photocatalyst coating material and stirred to obtain samples. Next, the samples were applied to glass plates, acrylic plates, and fluorescent lamp glass tubes and then dried at 120 to 180° C. to produce coating samples.

They were put in BOX made of a stainless steel and having a capacity of 1 m³ as an initial state. Successively, ultraviolet rays of 1 mW/cm² intensity were radiated to the glass plates and acrylic plates by a BLB lamp. The fluorescent lamps were lighted while being kept in the BOX as they were to measure the effect of decomposing formaldehyde. After the measurement, the samples were left in a room in the case of the glass plates and acrylic plates and the fluorescent lamps were subjected to a lighting test in a common work office to measure the gas decomposition capability for every week.

According to the second embodiment, magnesium oxide capable of easily absorbing SOₓ and NOₓ as compared with tungsten trioxide was properly added to the coating material containing the tungsten trioxide fine particles and the obtained photocatalyst coating material for indoor was used for forming a photocatalyst film on the fluorescent lamp main body. Consequently, effects such as disinfection and stain prevention unique to the photocatalyst film can be obtained. Further, deterioration of the photocatalyst film can be suppressed during the use and accordingly a fluorescent lamp with a long life can be obtained.

### Third Embodiment

At first, an aqueous solution (sample) containing 4% by weight of ammonium para-tungstate was sent to the inside of a spraying nozzle 53 shown in FIG. 7. Next, the solution was sprayed through the tip end of the spraying nozzle 53 in hot air-blowing atmosphere at 200° C. to atomize particles with a particle diameter of 1 to 10 μm and obtained a granular raw material. In this case, compressed air was sent to the periphery of the tip end of the spraying nozzle 53 from a pipe 55a to supply oxygen to the photocatalyst fine particles sprayed by the spraying nozzle 53. If the concentration of the aqueous solution is 4% by weight, a granular raw material of ammonium para-tungstate with 40 to 400 nm can be obtained. Next, rapid and short time heating under conditions of 800° C. for 1 to 10 minutes was carried out in the drying chamber 51 to forcibly dry the above-mentioned raw material and re-crystallized the material. As a result, tungsten trioxide photocatalyst fine particles containing tungsten trioxide fine particles as a main component, having an average particle diameter of 0.5 μm or smaller, preferably 0.1 μm or smaller, and a crystal structure of the monoclinic crystal system were obtained. Successively, while the inside air of the drying chamber 51 was evacuated by an aspirator 62, the photocatalyst fine particles in the drying chamber 51 were collected in a product container 61 by a cyclone 60.

According to the third embodiment, compressed air is sent to the periphery of the tip end of the spraying nozzle 53 through the pipe 55a and oxygen is supplied to the photocatalyst fine particles, so that the WO₃ crystal photocatalyst fine particles with few oxygen defects can be obtained. Further, the rapid and short time heating under conditions of 800° C. for 1 to 10 minutes is carried out in the drying chamber 51, so that the WO₃ crystal photocatalyst fine particles with scarce crystal growth can be obtained.

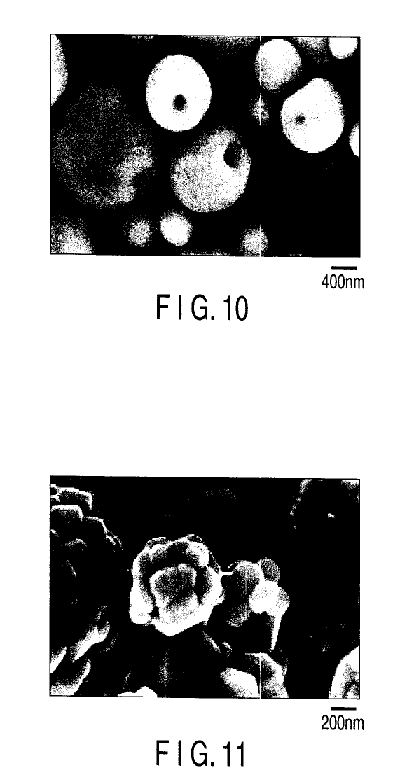

FIG. 10 shows a microscopic photograph of ammonium meta-tungstate as a granular raw material obtained in the third embodiment. FIG. 11 shows a microscopic photograph of monoclinic crystal system type WO₃ crystal photocatalyst fine particles obtained by rapid and short time heating of the granular raw material obtained in the third embodiment at 800° C. for 1 to 10 minutes. From FIG. 10, it is understood that although there is a slight difference, the granular raw material of ammonium meta-tungstate with an even particle diameter can be obtained.

### Fourth Embodiment

The fine particles of this embodiment are tungsten trioxide fine particles produced by heating and firing a raw material, which is obtained by dissolving commercialized ammonium para-tungstate in a water-based solvent and then carrying out recrystallization, at a high temperature for 1 minute in atmospheric air.

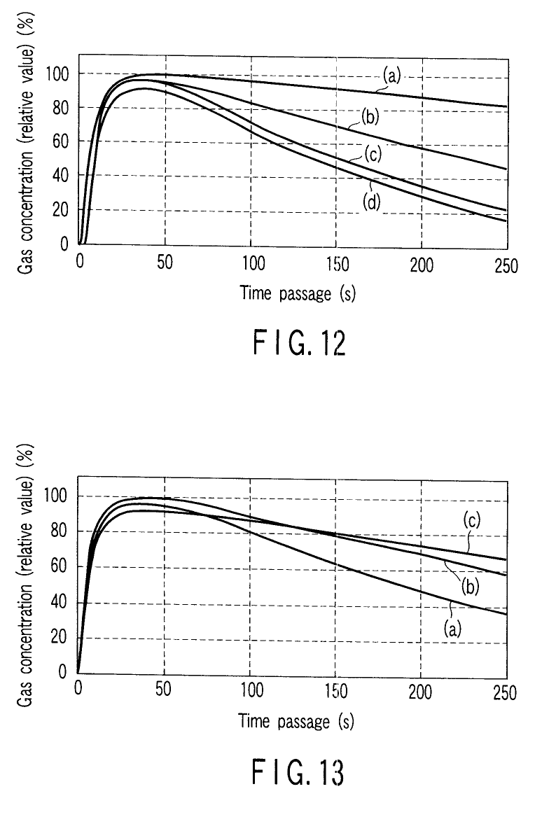

FIG. 12 shows a characteristic drawing showing the acetaldehyde decomposition capability of the respective tungsten trioxide photocatalyst fine particles obtained by changing the firing temperature to 600° C., 700° C., 800° C., and 900° C. in the fourth embodiment. In FIG. 12, the curve (a) shows the result in the case of 600° C.; the curve (b) shows the result in the case of 700° C.; and the curve (c) shows the result in the case of 800° C.

FIG. 13 shows a characteristic drawing showing the acetaldehyde decomposition capability of the respective tungsten trioxide photocatalyst fine particles obtained by firing at a temperature of 800° C., 900° C., and 1000° C. In FIG. 13, the curve (a) shows the result in the case of 800° C.; the curve (b) shows the result in the case of 900° C.; and the curve (c) shows the result in the case of 1000° C.

The decomposition capability evaluation shown in FIGS. 12 and 13 was carried out in the following conditions. At first, 0.1 g of tungsten trioxide fine particles were put in a laboratory dish and set in a closed container with a capacity of 200 cc. Next, a blue emitting LED was installed in the container in a manner that the light having the electroluminescence spectrum shown in FIG. 3 can be radiated to the photocatalyst fine particles. Successively, acetaldehyde gas was introduced in a proper concentration to adjust the acetaldehyde concentration in the container to be 10 ppm and simultaneously the blue emitting LED was lighted and the gas concentration fluctuation was measured with the lapse of time. The concentration measurement was carried out based on the output of a gas sensor installed in the container and evaluation was carried out by relative comparison of the output values.

The graphs of FIGS. 12 and 13 show the relative values (%) showing the output of the sensor corresponding to the concentration of acetaldehyde in the axis of ordinates. The container is filled with the gas within 20 to 30 seconds after introduction. After that, it is seen that the concentration is gradually decreased by the decomposition effect of the photocatalyst. In this connection, in FIGS. 12 and 13, the maximum value of the sensor output is set to be 100% for convenience.

From FIGS. 12 and 13, it is understood that the decomposition effect is highest in the case where the crystal, which is obtained by dissolving the commercialized ammonium para-tungstate as a raw material in water and carrying out recrystallization for fine granulation, is fired at 800° C. Therefore, the firing temperature is found to be preferable in a range from 700 to 900° C. In such a manner, the photocatalytic material of the fourth embodiment is more excellent in the visible light-response and has higher photocatalytic activity than tungsten oxide obtained simply by firing a commercialized product.

### Fifth Embodiment

Fine particles of this embodiment are tungsten trioxide fine particles obtained by the following procedure. That is, at first commercialized ammonium para-tungstate was dissolved in a water-based solvent. Next, the particles obtained by recrystallization were fired at 800° C. for a prescribed time in atmospheric air to produce the fine particles.

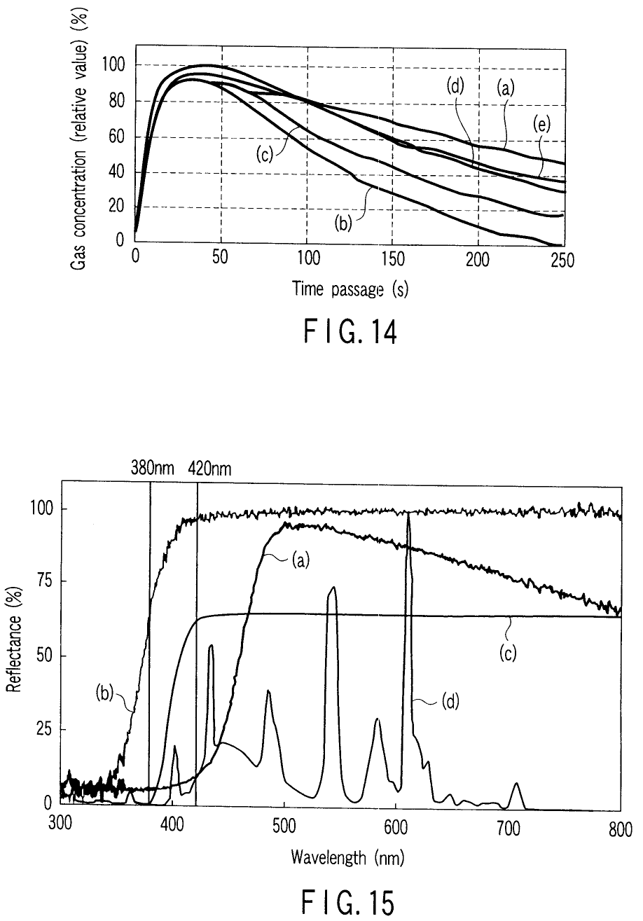

FIG. 14 shows a characteristic drawing showing the acetaldehyde decomposition capability in the case where the firing time was changed to be 30 seconds (the curve (a)), 1 minute (the curve (b)), 5 minutes (the curve (c)), 10 minutes (the curve (d)), and 15 minutes (the curve (e)). The decomposition capability evaluation conditions and the illustrated contents of the graph of FIG. 14 are the same as those of FIG. 12.

From FIG. 14, it is understood that high gas decomposition capability can be obtained if the firing temperature is adjusted to be 1 to 5 minutes.

### Sixth Embodiment

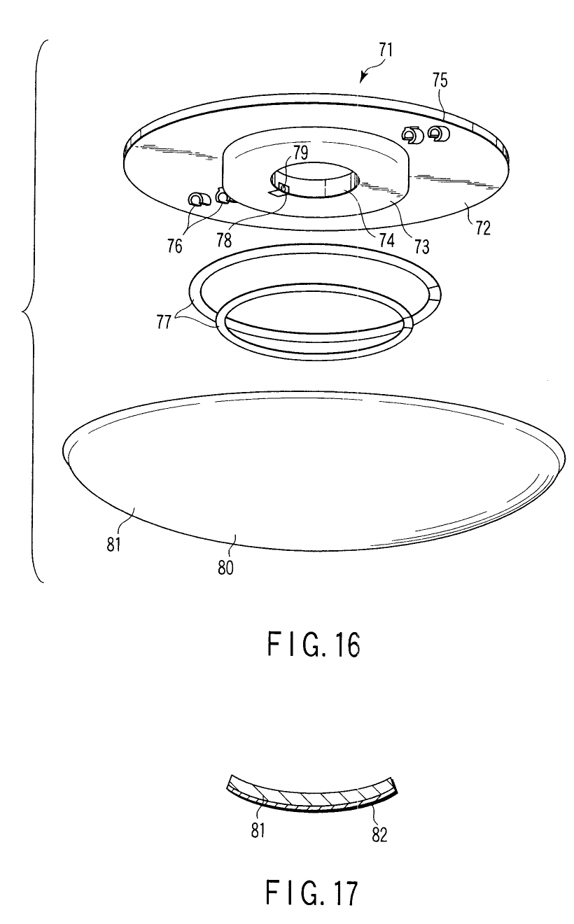

A lighting apparatus according to a sixth embodiment of the invention has the configuration shown in FIGS. 16 and 17. Herein, FIG. 16 shows a perspective view of the lighting apparatus in the disassembled state and FIG. 17 shows an enlarged cross-sectional drawing of the main part of FIG. 16. The sixth embodiment relates to the lighting apparatus using a transmissive shade (cover) in which a ultraviolet cut layer mainly containing a ultraviolet shutting material is formed in the inner face.

A lighting apparatus 71 is provided with a disk-like apparatus main body 72. The apparatus main body 72 is directly attached to the ceiling part by a hooking sealing installed in the ceiling and an adaptor to be attached to the hooking sealing. A step part 73 with a large thickness size is installed in the center part of the apparatus main body 72. A circular aperture part 74 in which the adaptor is inserted for mechanical connection is formed in the center part of the step part 73.

Further, two lamp sockets 75 and two lamp holders 76 are formed in the circumferential part of the apparatus main body 72. Two circular light emitting tubes of fluorescent lamps 77 to be light sources (for example, light emitting tubes of fluorescent lamps with 32 W and 40 W and mutually different outer diameters) are electrically and mechanically connected to the lamp sockets 75. Further, the two light emitting tubes 77 are mechanically supported by the lamp holders 76 and installed concentrically around the step part 73. A socket 78 is formed in a portion of the aperture part 74. A lamp 79 such as a baby bulb is installed in the socket 78.

A shade 80 as an optical part for lighting is attached to the apparatus main body 72 so as to be detached from the apparatus main body 72 and cover the apparatus main body 72 and the under and side parts of members attached to the apparatus main body 72. The shade 80 is provided with a cover substrate 81 for lighting made of an acrylic material. The cover substrate 81 is light transmissive just like glass or resins and formed to have a curved and smoothly downward projected shape. A photocatalyst layer 82 containing the tungsten trioxide fine particles having a crystal structure of the monoclinic crystal system and an average particle diameter of 0.1 μm is formed in the outer face of the substrate 81.

The above-mentioned photocatalyst layer 82 was formed as follows. That is, at first, commercialized ammonium para-tungstate (APT) with a size of about 100 μm as a raw material was crushed by a bead mill or a planetary mill to have an average particle diameter of 0.05 to 0.1 μm, and the obtained fine particles were heated at 500° C. for 8 hours in atmospheric air. Accordingly, tungsten trioxide fine particles were produced. Next, the tungsten trioxide fine particles and a binder component were dispersed in and mixed with a solvent to obtain a coating material. Successively, the coating material was applied to the substrate 81 by a spray gun and dried to form the layer.

According to the sixth embodiment, since the photocatalyst layer 82 was formed on the surface of the substrate 81 using the coating material obtained by dispersing the tungsten trioxide fine particles and the binder component, there is no need to carry out heating treatment at a high temperature after the coating formation. As a result, the substrate such as an organic substrate as an object to be coated is provided with the photocatalyst function, and even in the case where the coating is formed on the acrylic cover outer face, sufficient activity can be obtained.

In the sixth embodiment, although the photocatalyst layer 82 is formed on the outer face of the substrate 81, the configuration is not limited thereto and the layer may be formed integrally by mixing the photocatalytic material with the resin composing the substrate 81.

FIG. 15 shows the relation between the wavelength and the reflectivity in the case of using WO₃ photocatalyst (curve (a)) of the sixth embodiment and TiO₂ photocatalyst (curve (b)). The curve (c) of FIG. 15 shows the acrylic cover transmittance and the curve (d) shows the spectroscopic distribution of light radiated from a three-light emitting type fluorescent lamp. From FIG. 15, it is understood that tungsten trioxide of the sixth embodiment efficiently absorbs, as the energy for photocatalyst activation, blue- and green-visible light with wavelength of 400 to 500 nm transmitted through the acrylic cover.

### Seventh Embodiment

This embodiment provides a configuration of a reflection substrate made of a color steel plate for lighting and coated with a WO₃ photocatalyst layer. The photocatalyst layer was formed as follows.

That is, commercialized ammonium para-tungstate (APT) with a size of about 100 μm as a raw material was crushed by a bead mill or a planetary mill to have an average particle diameter of 0.05 to 0.1 μm. Next, the obtained fine particles were heated at 500° C. for 8 hours in atmospheric air to produce tungsten trioxide fine particles. Successively, the tungsten trioxide fine particles and a binder component were dispersed in and mixed with a solvent to obtain a coating material. Further, the coating material was applied to the reflection substrate made of the color steel plate by a spray gun and dried to form the layer.

The effect similar to that of the sixth embodiment can be obtained in the seventh embodiment.

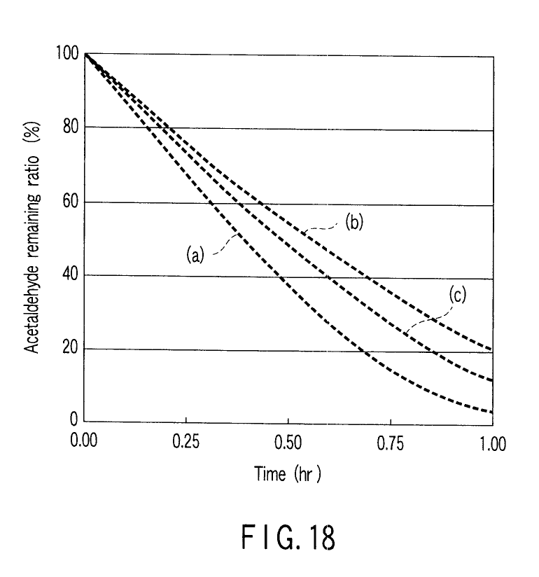

FIG. 18 shows the relation between the time and the acetaldehyde remaining ratio in the case of using the lighting apparatus of the seventh embodiment in combination with a TiO₂ photocatalyst-bearing fluorescent lamp (curve (a)), the TiO₂ photocatalyst-bearing fluorescent lamp (curve (b)), and a TiO₂ photocatalyst-bearing lighting apparatus in combination with the TiO₂ photocatalyst-bearing fluorescent lamp (curve (c)). As is clear from the graph of FIG. 18, the photocatalyst layer formed on the surface of the reflection plate substrate of the lighting apparatus is more excellent in the photocatalyst effect in the case of using monoclinic crystal system tungsten trioxide fine particles than in the case of using TiO₂ fine particles as before.

What is claimed is:

1. A photocatalytic material containing tungsten trioxide fine particles having an average particle diameter of 0.5 μm or smaller and a crystal structure of a monoclinic crystal system as a main component.

2. A photocatalyst body comprising a layer of the photocatalytic material according to claim 1 formed on a substrate surface and a photocatalyst film containing tungsten trioxide fine particles maintaining a crystal structure of a monoclinic crystal system and formed on the layer of the photocatalytic material.

3. A photocatalytic product comprising a photocatalyst filter and a light emitting diode which radiates light including at least blue color light to the photocatalyst filter, wherein the photocatalytic material according to claim 1 is deposited on the photocatalyst filter and tungsten trioxide fine particles maintain a crystal structure of a monoclinic crystal system after deposition.

4. A lighting apparatus comprising a light source, a light transmissive cover substrate enveloping the light source, and a photocatalyst layer formed on an outer face or an inner face of the cover substrate and containing tungsten trioxide fine particles having an average particle diameter of 0.1 μm or smaller and a crystal structure of a monoclinic crystal system.

5. A lighting apparatus comprising a light source, a reflection plate substrate set optically on the opposite to the light source, and a photocatalyst layer formed on the reflection plate substrate and containing tungsten trioxide fine particles having an average particle diameter of 0.1 μm or smaller and a crystal structure of a monoclinic crystal system.

6. A method of producing a photocatalytic material comprising the steps of producing a granular raw material by spraying an aqueous solution containing 1 to 20% by weight of ammonium para-tungstate in high temperature atmosphere, and forming tungsten trioxide fine particles having a crystal structure of a monoclinic crystal system by heating the granular raw material at 700 to 800° C. for 1 to 10 minutes.

7. A method of producing a photocatalytic material comprising the steps of dissolving ammonium para-tungstate in a water-based solvent and successively carrying out recrystallization, and forming a tungsten trioxide photocatalytic material by firing the obtained crystal in conditions of 600° C. or higher for 15 seconds or longer.
